(19) United States
(12) Patent Application Publication
(10) Pub. No.: US 2023/0082037 A1
(43) Pub. Date: Mar. 16, 2023

(54) REMOVABLE MOUNTING DEVICES

(71) Applicant: Steven Robert Brennan, Minneapolis, MN (US)

(72) Inventor: Steven Robert Brennan, Minneapolis, MN (US)

(21) Appl. No.: 17/650,477

(22) Filed: Feb. 9, 2022

Related U.S. Application Data
(60) Provisional application No. 63/200,073, filed on Feb. 12, 2021.

(51) Int. Cl. A47G 1/17

(52) U.S. Cl. CPC A47G 1/17

(57) ABSTRACT

An example removable mounting device can include: a main body; a flap portion coupled to the main body, wherein the flap portion pivots relative to the main body; and an adhesive applied to a back side of the main body and the flap portion; wherein the main body is configured to be removably coupled to a surface by the adhesive; and wherein the flap portion is configured to be removably coupled to an item by the adhesive to hang the item on the surface.

### RELATED APPLICATION(S)

This patent application claims the benefit of U.S. Patent Application No. 63/200,073 filed on Feb. 12, 2021, the entirety of which is hereby incorporated by reference.

### BACKGROUND

Tape or other adhesives can be used to hang items on objects such as walls or refrigerators. However, the tape does not always work to hold the item and can result in damage to the item and/or the object to which the item is attached.

### SUMMARY

In one aspect, an example removable mounting device can include: a main body; a flap portion coupled to the main body, wherein the flap portion pivots relative to the main body; and an adhesive applied to a back side of the main body and the flap portion; wherein the main body is configured to be removably coupled to a surface by the adhesive; and wherein the flap portion is configured to be removably coupled to an item by the adhesive to hang the item on the surface.

### DESCRIPTION OF FIGURES

FIG. 1 shows an example removable mounting device.

FIG. 2 shows another view of the removable mounting device of FIG. 1.

FIG. 3 shows an example item to be hung by the removable mounting device of FIG. 1.

FIG. 4 shows another view of the item of FIG. 3 with the removable mounting device of FIG. 1 affixed thereto.

FIG. 5 shows another view of the item and the removable mounting device of FIG. 4.

FIG. 6 shows another view of the item and the removable mounting device of FIG. 4 affixed to an object.

FIG. 7 shows another view of the item and the removable mounting device of FIG. 4 affixed to the object of FIG. 6.

FIG. 8 shows an example removable mounting device.

FIG. 9 shown another view of the removeable mounting device of FIG. 8 affixed to an object.

FIG. 10 shows another view of the removeable mounting device and the object of FIG. 9.

FIG. 11 shows another view of the removeable mounting device and the object of FIG. 9 affixed to an item.

FIG. 12 shows another view of the removeable mounting device and the object of FIG. 9 affixed to the item of FIG. 11.

FIG. 13 shows another view of the removeable mounting device and the object of FIG. 9 affixed to the item of FIG. 11.

FIG. 14 shows another example removeable mounting device affixed to another item.

FIG. 15 shows another example removeable mounting device affixed to another item.

FIG. 16 shows another example removeable mounting device affixed to another item.

FIG. 17 shows another example removeable mounting device affixed to another item.

FIG. 18 shows an example page including a plurality of the removeable mounting device of FIG. 8.

### DETAILED DESCRIPTION

Examples described herein are related to removable mounting devices. The mounting devices are configured to removably hang items on surfaces.

Embodiments may be configured to be used with or as part of a piece of mail, post card, holiday card, advertisement, flier, photo, newspaper insert, etc. Configurations may be processed by mail systems, such as the U.S. Post Office, FedEx or UPS, such that the removable mounting device may flow through such systems and mail sorters, regardless of the reasonable variations in conditions, such as temperature and humidity or the types of machines used for handling mail. Example embodiments may be included on or as part of an item, such as a post card, holiday card, or picture, with or without an encasing or envelope.

In one example, a mounting device includes an adhesive. The adhesive holds the mounting device to a surface. The adhesive also holds the mounting device to an item. This allows the mounting device to hold the item on the surface. The adhesive may be configured to allow the mounting device to be removed from the surface leaving no noticeable or barely noticeable adhesive or marks on the surface. The adhesive may also be configured to allow the mounting device to be removed from the item leaving no noticeable or barely noticeable adhesive or marks on the item.

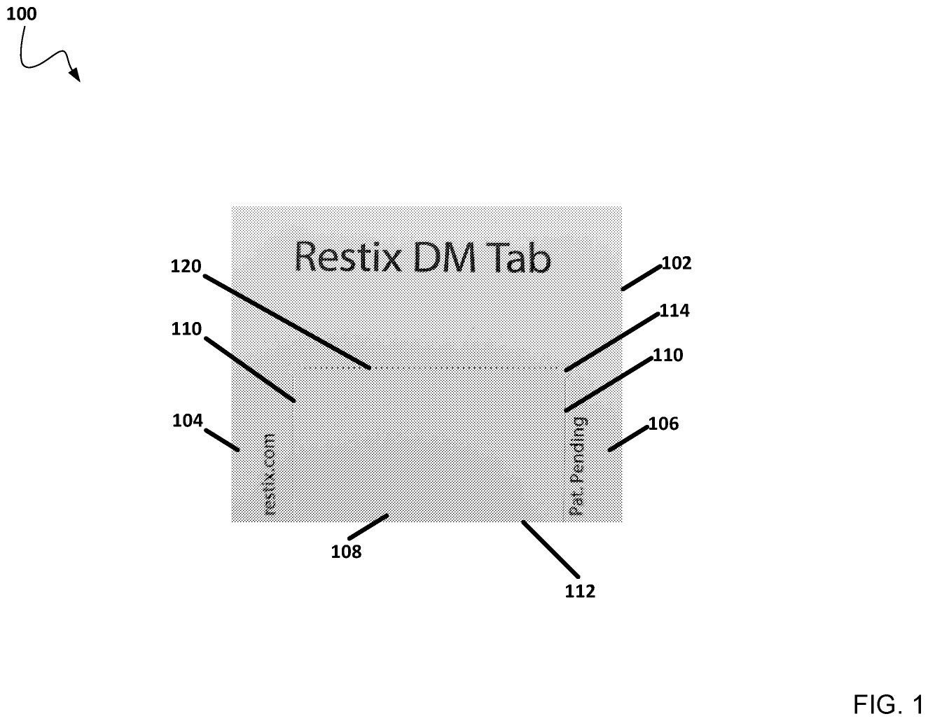

Referring now to FIGS. 1-8, an example removable mounting device 100 is shown. In this example, the mounting device 100 includes a main body 102. Two slits 110 are kiss cut in the main body 102. As shown, each of the slits 110 runs from an edge 112 of the main body 102 through a portion of the main body 102. A curved portion 114 formed at an end of each of the slits 110 resists further ripping of the main body 102 while the mounting device 100 is in use.

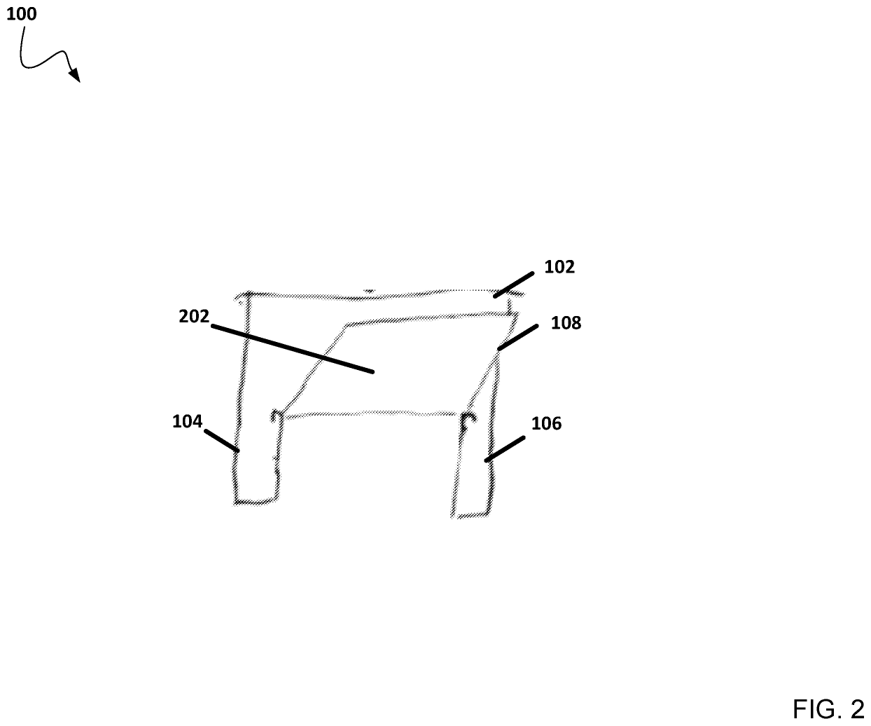

The slits 110 in the main body 102 generally form a flap portion 108 that can be released and pivoted along an imaginary hinge line 120 (added to generally indicate the area at which the flap portion 108 pivots), while portions 104 and 106 of the main body 102 remain in place, as shown in FIG. 2. A back side of the main body 102, including an inner surface 202 of the flap portion 108, includes an adhesive.

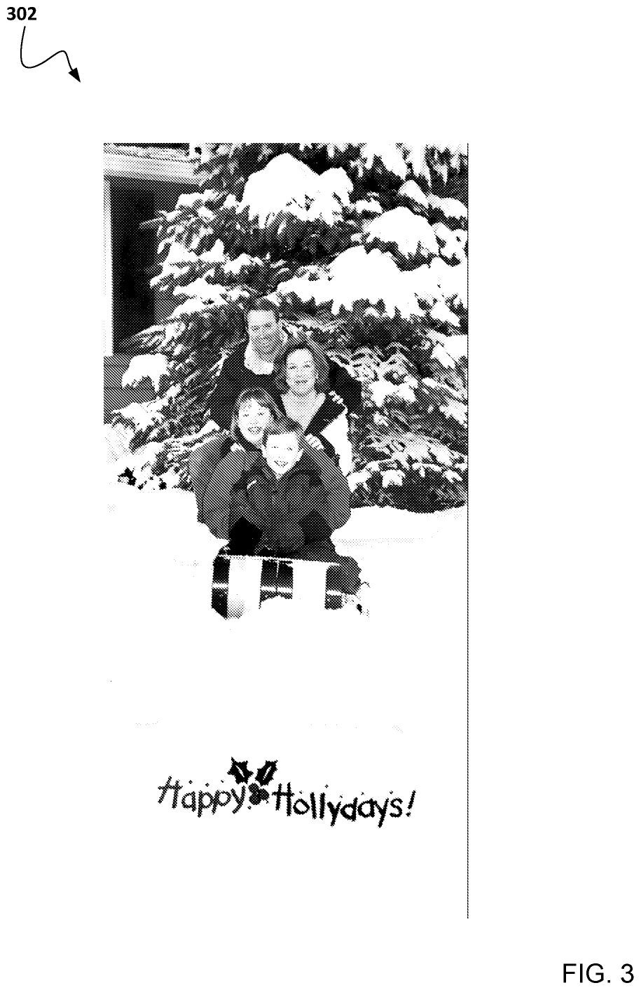

For instance, referring now to FIGS. 3-7, another example removable mounting device 300 is shown affixed to an item 302. In this example, the item 302 includes a picture, such as a holiday card. In this example, text and graphics 320 (“Happy Holiday” and associated holiday graphic) are printed on the mounting device 300.

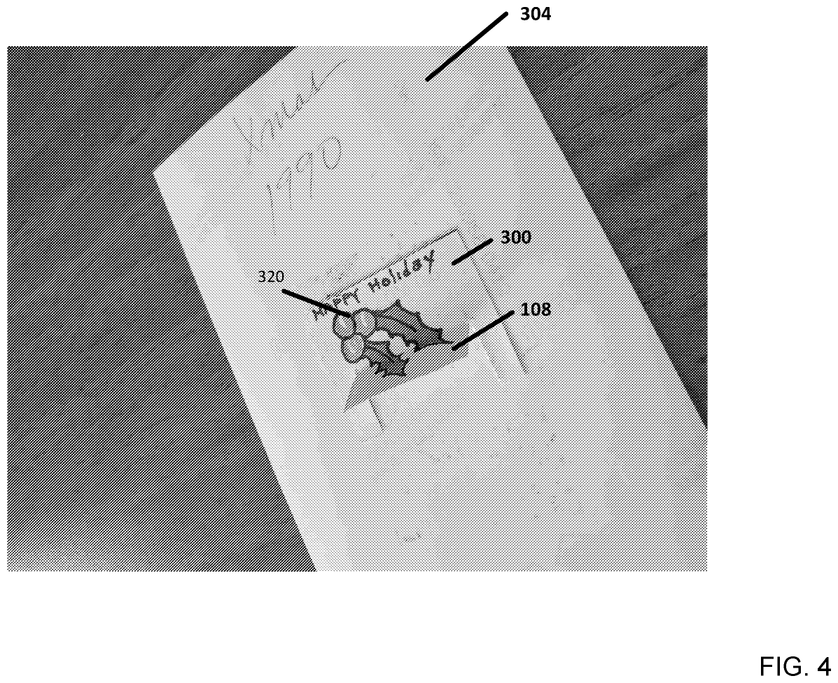

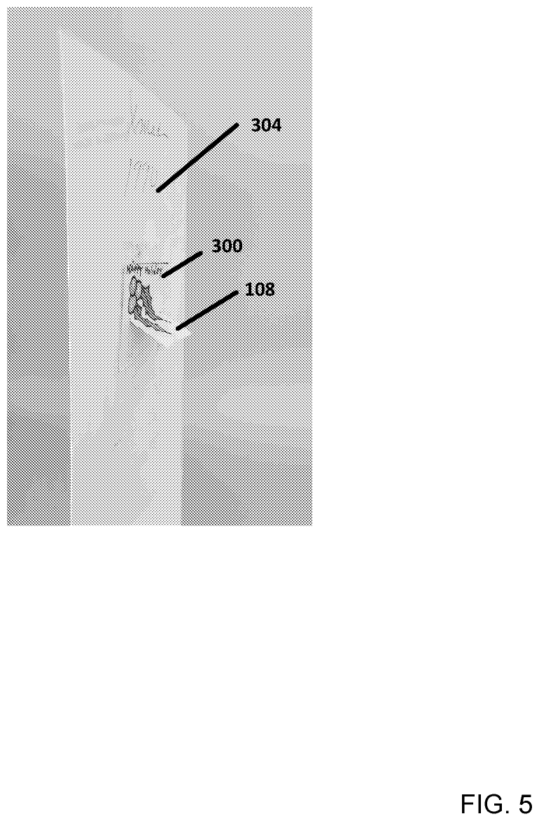

As shown in FIGS. 4-5, the mounting device 300 is removably affixed to a back surface 304 of the item 302 by the adhesive on the back side of the mounting device 300. In this example, the back surface 304 of the item 302 is photo printer paper. Other types of paper or material can be used.

The mounting device 300 can be applied to the back surface 304 of the item 302 by pressing the mounting device 300 against the back surface 304 of the item 302 to allow the adhesive to removably couple the mounting device 300 to the item 302. This can be done in an automated or manual fashion, as described further below. The flap portion 108 of the mounting device 300 can be pulled away from the back surface 304 to couple the mounting device to a surface.

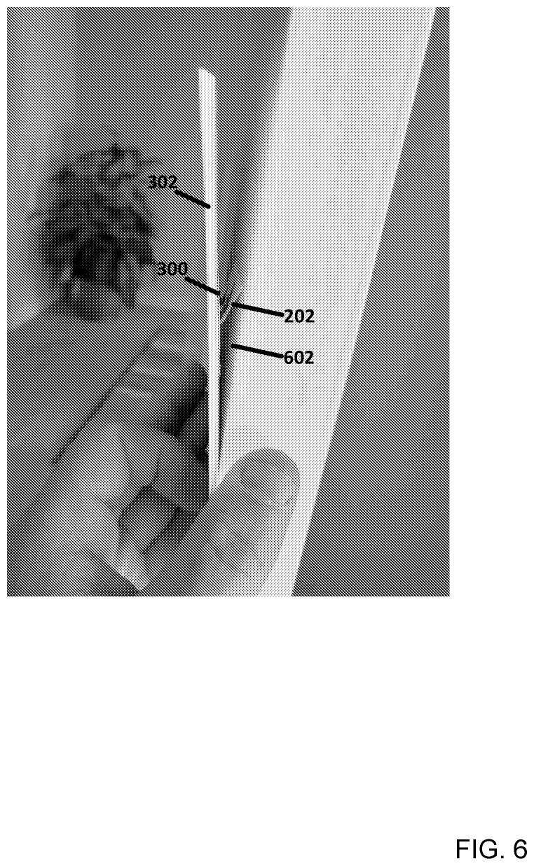

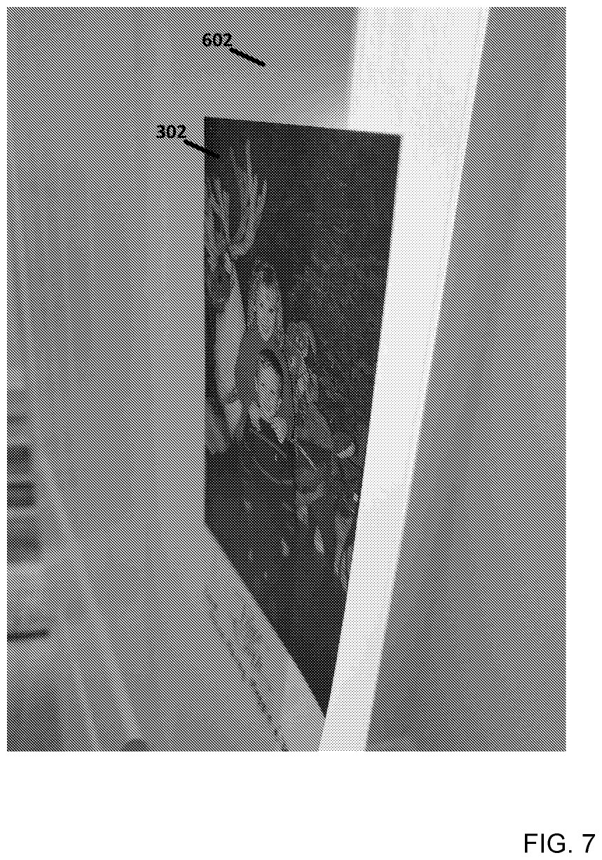

As shown in FIG. 6, the flap portion 108 can be pivoted approximately 180 degrees to expose the inner surface 202 of the flap portion 108 with the adhesive. In this position, the inner surface 202 of the flap portion 108 can be pressed against a surface 602 to couple the mounting device 300 (and associated item 302) to the surface 602, as shown in FIG. 7. In this configuration, the mounting device 300 removably hangs the item 302 on the surface 602.

The surface 602 can be any surface where it is desirable to hang the item 302. For instance, the surface 602 can be a wall, door, refrigerator, etc., potentially any desired surface or material.

When desired, the item 302 can be removed from the surface 602 by the user pulling the item 302 away from the surface 602. The adhesive on the inner surface 202 of the flap portion 108 releases the surface 602 leaving no noticeable or barely noticeable adhesive or marks on the surface 602. The mounting device 300 can thereupon be used to mount the item 302 to another surface, if desired. The mounting device 300 can also be removed from the item 302 by the user pulling the mounting device 300 off of the item 302. This results in the mounting device 300 leaving noticeable or barely noticeable adhesive or marks on the item 302.

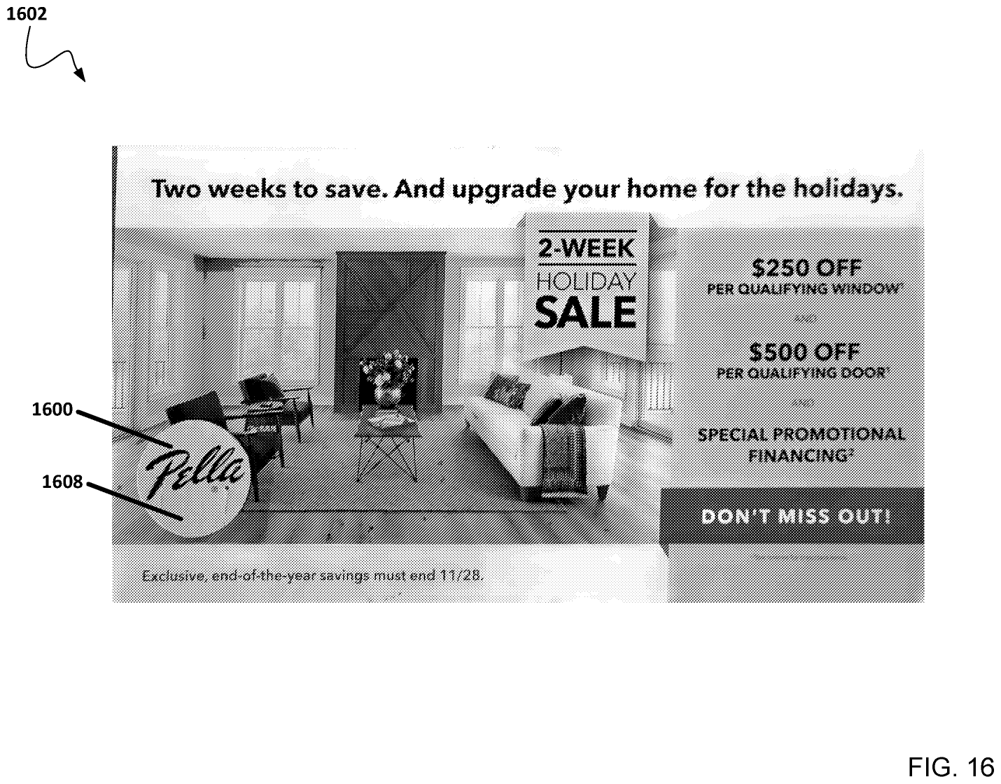

In some examples, the mounting device 300 and associated adhesive are configured to removably hang items such as pictures (e.g., 3 inches by 5 inches, 4 inches by 6 inches), greeting cards (e.g., 4 inches by 6 inches, 5 inches by 7 inches), and other similarly-sized items. Larger items, such as jumbo postcards of 6 inches by 11 inches (see FIG. 16) can also be hung by the mounting device 300. Further, multiple mounting devices can be used to hang larger or heavier items.

As previously noted, the adhesive used is strong enough to hold the mounting device on the mounting surface and couple the mounting device to the item being hung. The adhesive is also removable so that little or almost no adhesive is left on the mounting surface or item when removed. In one example, the adhesive is a Fasson® R120 adhesive applied to Fasson® Laser Code™ II vinyl (Standard Product Data Sheet #79718) provided by Avery Dennison Corporation. Many other types of adhesives can be used.

The adhesive can be applied to the entire back side surface. In potential other embodiments, the adhesive may be applied to only a portion of a surface of the mounting device. It may also be applied to the mounting device using a pattern where only a certain percentage of the entire side of the mounting device is covered by the adhesive. The pattern could be lines, “x's”, a dot matrix, or a pattern of shapes or any desired shape.

The adhesive may also be applied at different rates or densities deepening on the area part of the surface to provide different levels of adhesion for different parts of the mounting device depending on its intended use. For example, the inner surface 202 may have more adhesive to provide a better adhesion depending on the intended use. In addition to having different parts of the mounting device have different amounts of adhesive or different areas covered by adhesive, the mounting device may also use two or more different types of adhesives. For example, a stronger adhesive can be used on the inner surface 202 than other parts of the mounting device or vice versa. Other arrangements, types of adhesives, numbers of adhesives, various portions covered with adhesive of the mounting device could also be used.

In one example, the mounting devices 100, 300 are each 1.25 inches in height and 1.5 inches in width. The slits 110 are 0.625 inches long. Other sizes and configurations for removable mounting devices are possible. For instance, the size, shape, and/or coloring of the removable mounting devices can be modified as desired to fit an intended use.

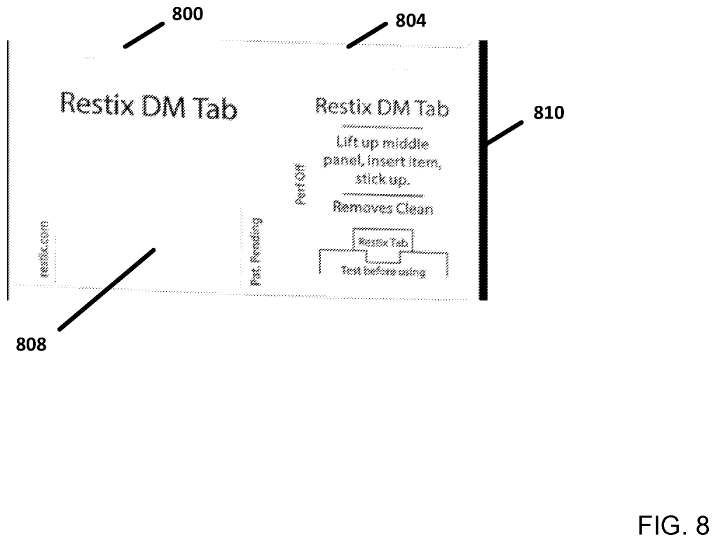

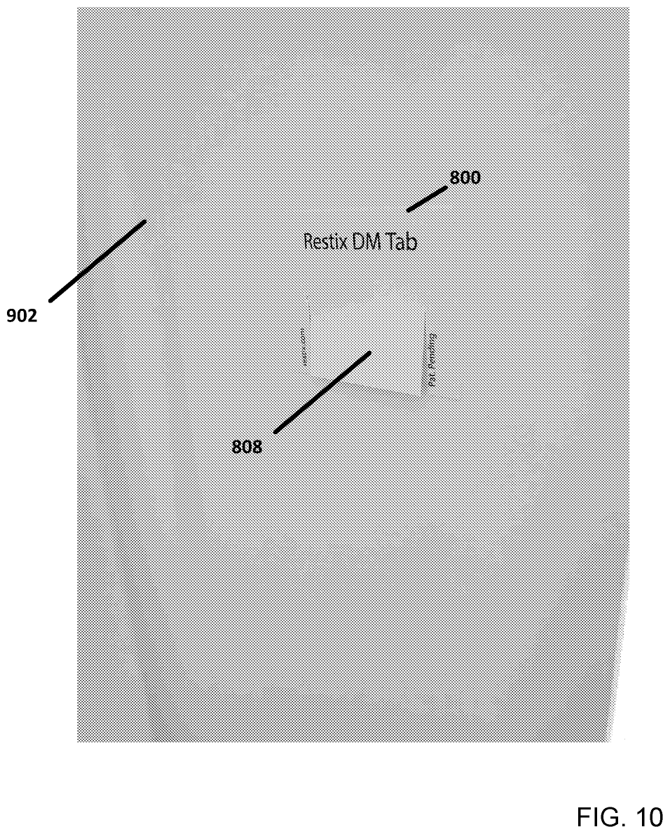

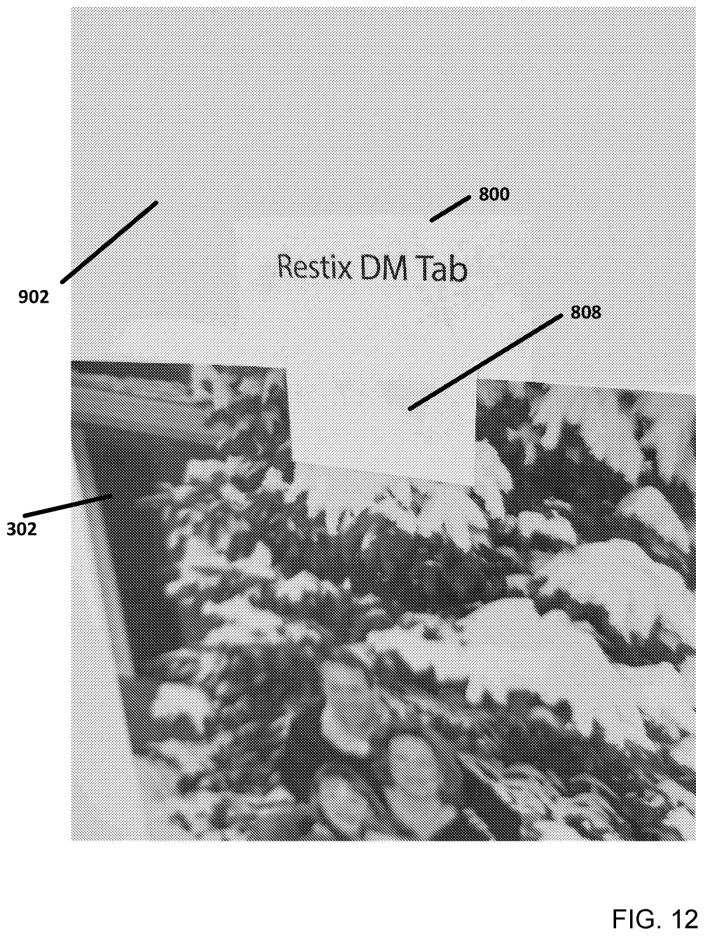

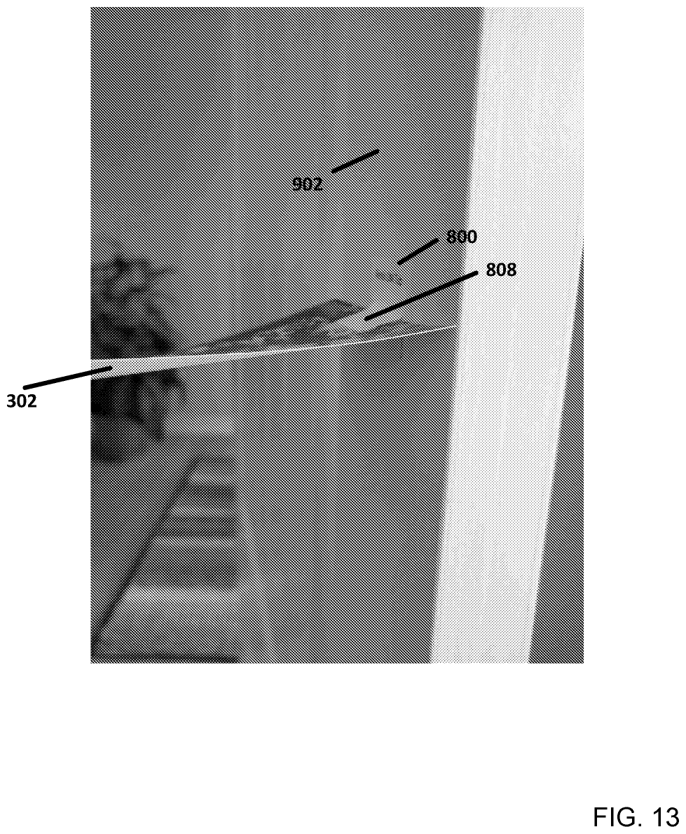

For instance, referring now to FIGS. 8-13, another example removable mounting device 800 is shown. In this example, the mounting device 800 is affixed to a backing paper 810 that allows the mounting device 800 to be easily removed and applied to a surface and item.

The backing paper 810 also includes a text portion 804 with instructions for use (“Lift up middle panel, insert item, stick up”) of the mounting device 800. The mounting device 800 functions similarly to the mounting devices 100, 300 described previously, except a flap portion 808 of the mounting device 800 does not need to be pivoted 180 degrees for use.

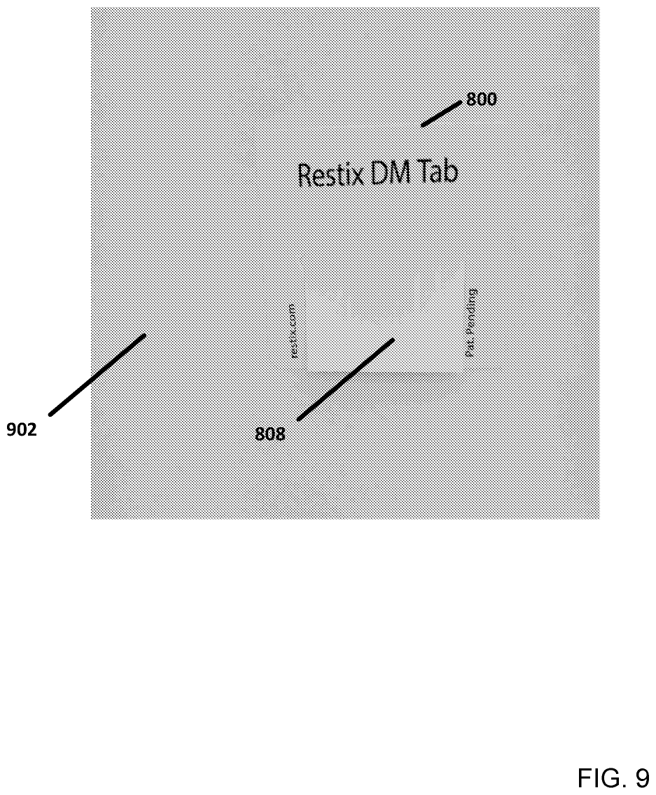

Instead, as shown in FIGS. 9-13, the mounting device 800 can be used by removing the mounting device 800 from the backing paper 810 and applying the mounting device 800 to a desired surface 902. The adhesive on the back side of the mounting device 800 holds the mounting device 800 on the surface 902.

Once in place, the flap portion 808 is pulled slightly away from the surface 902, and the item 302 is slid under the flap portion 808 until an upper edge 1102 of the item 302 is generally positioned under the flap portion 808.

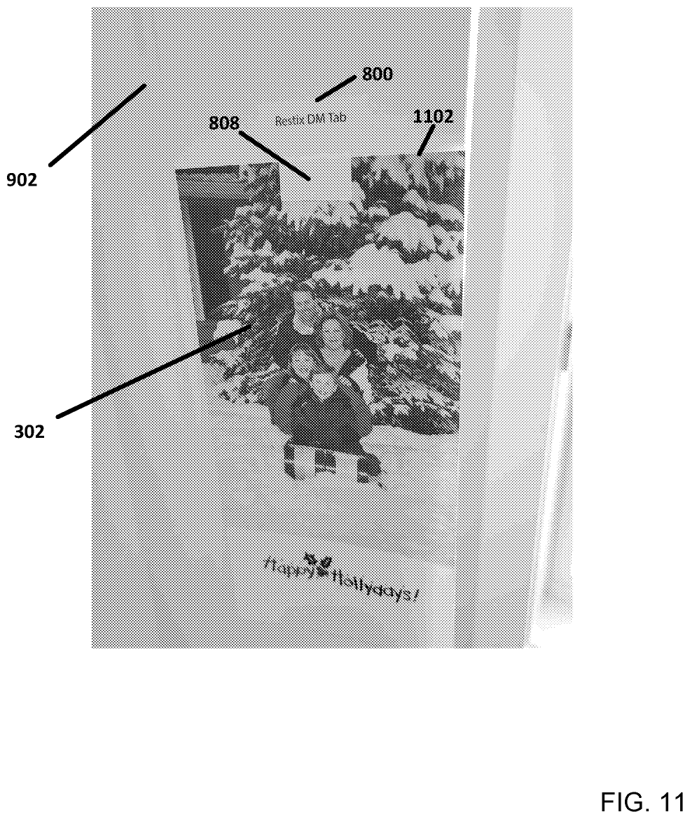

In this configuration, the user can press the flap portion 808 against the upper edge 1102 of the item 302 to couple the item 302 to the mounting device 800 (and associated surface 902), as shown in FIGS. 11-13. In this configuration, the mounting device 800 removably hangs the item 302 on the surface 902.

Further, the flap portion 808 can generally move with the item 302 so that the item 302 is retained even if the item undergoes changes. For instance, if the item 302 “cups” or otherwise changes shape because of aging or modifications in the environment (temperature and/or humidity), the flap portion 808 is maintained in contact with the item 302 and continues to hang the item 302.

When desired, the item 302 can be removed from the surface 902 by the user pulling the item 302 away from the mounting device 800. The adhesive on the inner surface 202 of the flap portion 808 releases the item 302 leaving no noticeable or barely noticeable adhesive or marks on the item 302. The mounting device 800 can thereupon be used to mount other items to the surface 902, if desired. The mounting device 800 can also be removed from the surface 902 by the user pulling the mounting device 800 off of the surface. Again, no or barely noticeable adhesive or marks are left on the surface 902 after removal.

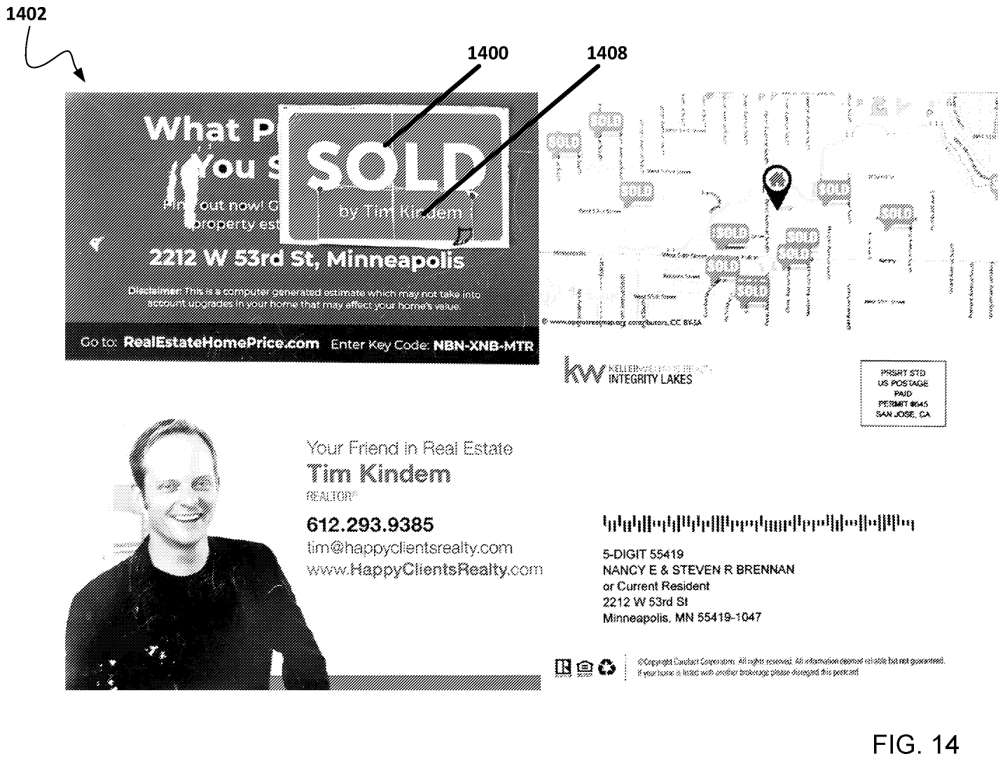

The removable mounting devices can be used in a variety of other applications. For instance, as shown in FIGS. 14-16, the removable mounting devices can be applied to items that are sent through the mail, such as postcards, envelopes, coupons, and other similar mailers.

In FIG. 14, a removable mounting device 1400 is applied to a postcard 1402. The mounting device 1400 can be applied before the postcard 1402 is mailed. For instance, the user can manually apply the mounting device 1400 to the postcard 1402 by placing the mounting device 1400 onto the postcard 1402 so that the adhesive on the back side of the mounting device 1400 holds the mounting device 1400 to the postcard 1402.

In other examples, the removable mounting device 1400 is applied to the postcard 1402 through an automated application. This process the automated application of the removable mounting device to an item, such as a postcard or other mail item. In such an example, labeling equipment from Label-Aire, Inc. can be used to automatically apply removable mounting devices to items. Other configurations are possible.

Whether placed manually or automatically onto the postcard 1402, the mounting device 1400 is configured to remain intact on the mail item as the mail item is transported through the postal system. For instance, the mounting device 1400 is configured to stay in place on the mail item as the mail item goes through the rollers used by the postal system to process the mail. This is accomplished through use of a proper adhesive for the mounting device, which minimizes the possibility of the mounting device becoming dislodged from the mail item as the mail item is handled by the postal system.

The mounting device 1400 includes advertising information printed thereon. The mounting device 1400 allows the recipient to mount the postcard 1402 using the mounting device 1400. For instance, a flap portion 1408 of the mounting device 1400 can be used to mount the postcard 1402 to a refrigerator or other surface. This can be desirable, for instance, when postcard 1402 includes an advertisement or coupon, and the user wishes to save the postcard 1402 for later use.

For instance, the mounting device can include information relating to a business, such as a business name, logos, slogans, address, phone number, and/or web site address. The mounting device can be applied to a post, coupon, or other item associated with the business. The item including the mounting device can be delivered to the user, and the user can use the mounting device to hang the item. Further, if the item expires, such as a coupon, or otherwise is no longer needed, the user can remove the mounting device from the item. The user can thereupon use the mounting device to hang other items. The mounting device can continue to function as advertising in such a scenario, since the mounting device includes the business information printed thereon.

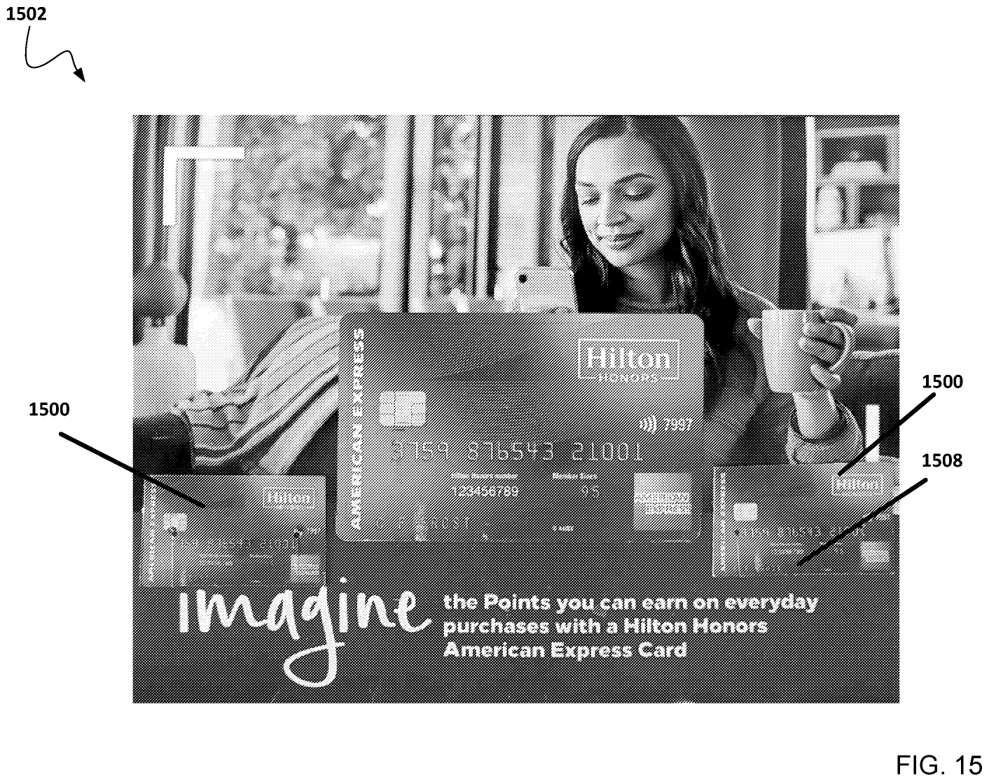

Referring now to FIG. 15, an example mailer 1502 includes multiple removable mounting device 1500 positioned thereon. In this example, the mounting devices 1500 are printed to depict an item associated with the mailer 1502 (e.g., in this instance, the mounting devices 1500 are printed to resemble credit cards with associated branding and logos). In other alternatives, the mounting devices can be colored differently or made to be transparent so that imaging or coloring under the mounting devices are visible.

The mounting devices 1500 can be used to mount the mailer 1502 to a surface by pivoting a flap portion 1508 on each. Alternatively, the mounting devices 1500 can be removed from the mailer 1502 and used to mount other items to other surfaces.

In FIG. 16, an example postcard 1602 includes a removable mounting device 1600 that is shaped (circular) and branded (with colors and trademarks). The mounting device 1600 can be used to hang the postcard 1602 or other items, as desired.

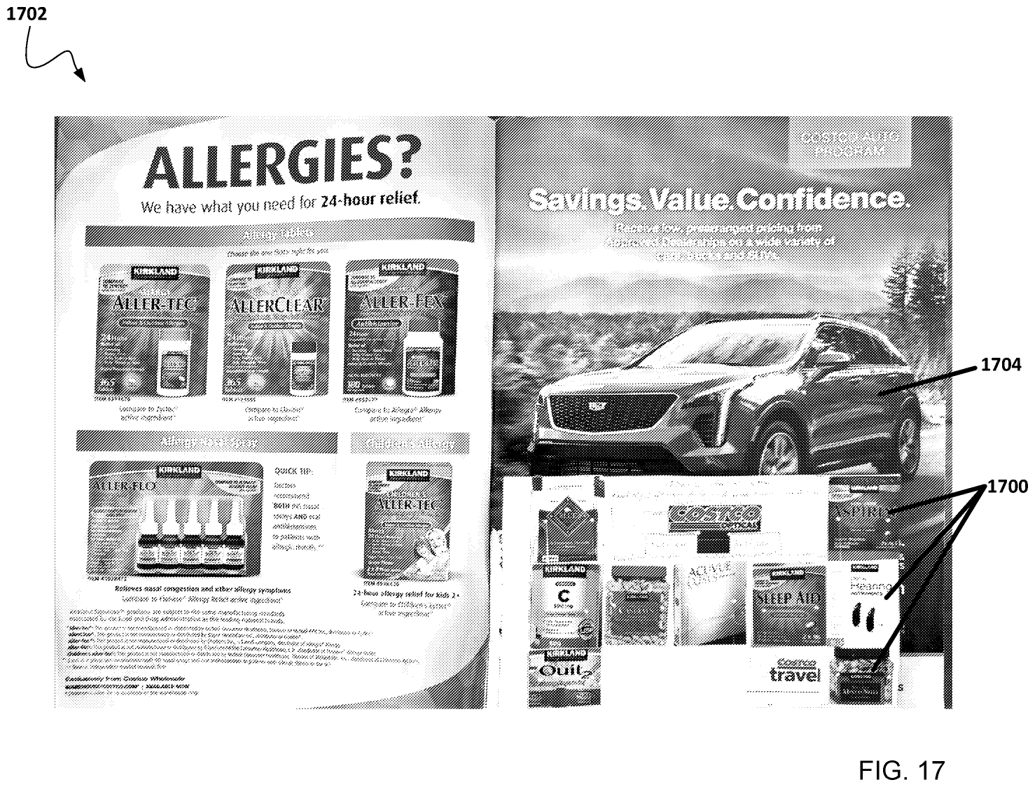

Referring now to FIG. 17, an example of a magazine 1702 is shown. In this example, multiple removable mounting devices 1700 are attached to one or more of the pages 1704 of the magazine 1702. Each of the mounting devices 1700 is printed with different branding. The mounting devices 1700 can be removed from the page 1704 of the magazine 1702 and used to hang different items to different surfaces. The branding is desirably retained in application of the mounting devices 1700.

The removable mounting devices can be delivered to the user in various manners. For instance, as noted above, the mounting devices can be affixed to mail items and magazine pages before the mail items and magazines are delivered. In other examples, the mounting devices can be delivered separately for use by the user.

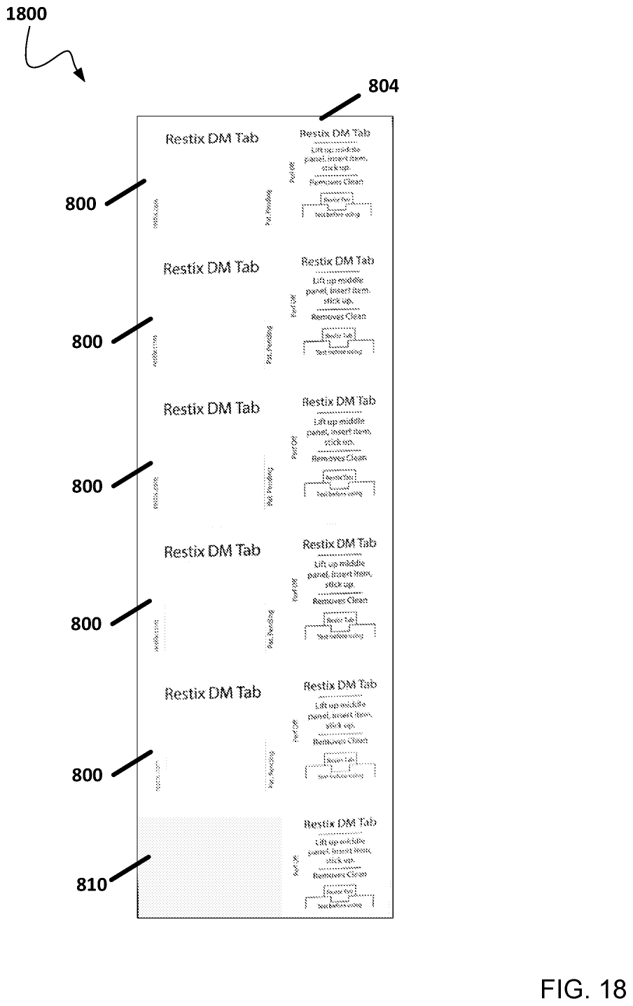

For example, as shown in FIG. 18, a plurality of the mounting devices 800 are delivered to the user attached to a page 1800 of the backing paper 810. The user can remove one of the mounting devices 800 when desired to affix an item to a surface.

For example, the page 1800 with the plurality of mounting devices 800 can be delivered along with an order of developed pictures. The mounting devices 800 can thereupon be used to mount one or more of the pictures by applying the mounting devices 800 to the pictures and desired surfaces as described herein. The mounting is accomplished with marking of the pictures.

Yet other configurations are possible. For example, in another embodiment, a mounting device can be integrated as a portion of the item itself. For instance, a portion of a photo or greeting card can be removed and the mounting device applied during manufacture of the photo or greeting card. Many other configurations are possible.

Although various embodiments are described herein, those of ordinary skill in the art will understand that many modifications may be made thereto within the scope of the present disclosure. Accordingly, it is not intended that the scope of the disclosure in any way be limited by the examples provided.

What is claimed is:

1. A removable mounting device, comprising:
a main body;
a flap portion coupled to the main body, wherein the flap portion pivots relative to the main body; and
an adhesive applied to a back side of the main body and the flap portion;
wherein the main body is configured to be removably coupled to a surface by the adhesive; and
wherein the flap portion is configured to be removably coupled to an item by the adhesive to hang the item on the surface.
